(19) United States
(12) Patent Application Publication
(10) Pub. No.: US 2015/0193088 A1
(43) Pub. Date: Jul. 9, 2015

(54) HANDS-FREE ASSISTANCE

(71) Applicant: INTEL CORPORATION, SANTA CLARA, CA (US)

(72) Inventors: Dayong Ding, Beijing (CN); Jiqiang Song, Beijing (CN); Wenlong Li, Beijing (CN); Yimin Zhang, Beijing (CN)

(21) Appl. No.: 14/124,847

(22) PCT Filed: Jul. 15, 2013
(86) PCT No.: PCT/US2013/050492

§ 371 Date: Dec. 9, 2013

(51) Int. Cl. G06F 3/042; G06F 3/0488

(52) U.S. Cl. CPC G06F 3/0425; G06F 3/04883; G06F 2203/04808

(57) ABSTRACT

Apparatuses, systems, media and/or methods may involve providing work assistance. One or more user actions may be recognized, which may be observed by an image capture device, wherein the user actions may be directed to a work surface incapable of electronically processing one or more of the user actions. One or more regions of interest may be identified from the work surface and/or content may be extracted from the regions of interest, wherein the regions of interest may be determined based at least on one or more of the user actions. Additionally, one or more support operations associated with the content may be implemented.

### BACKGROUND

Embodiments generally relate to assistance. More particularly, embodiments relate to an implementation of support operations associated with content extracted from regions of interest, related to work surfaces, based on user actions to provide hands-free assistance.

Assistance may include providing information to a user when the user is interacting with a surface, such as when the user is reading from and/or writing to a paper-based work surface. During the interaction the user may pause a reading task and/or a writing task to switch to a pen scanner for assistance. The user may also pause the task to hold a camera and capture content to obtain a definition. Such techniques may unnecessarily burden the user by, for example, requiring the user to switch to specialized implements, requiring the user to hold the camera or to hold the camera still, and/or interrupting the reading task or the writing task. In addition, assistance techniques may involve a content analysis process that uses reference material related to the work surface, such as by accessing a reference electronic copy of a printed document. Such content analysis processes may lack a sufficient granularity to adequately assist the user and/or unnecessarily waste recourses such as power, memory, storage, and so on.

### BRIEF DESCRIPTION OF THE DRAWINGS

The various advantages of embodiments will become apparent to one skilled in the art by reading the following specification and appended claims, and by referencing the following drawings, in which:

FIG. 1 is a block diagram of an example of an approach to implement support operations associated with content extracted from regions of interest related to a work surface based on user actions according to an embodiment;

FIG. 2 is a flowchart of an example of a method to implement support operations associated with content extracted from regions of interest related to a work surface based on user actions according to an embodiment;

FIG. 3 is a flowchart of an example of a display-based method to implement support operations associated with content extracted from regions of interest related to a work surface based user actions according to an embodiment;

FIG. 4 is a block diagram of an example of a logic architecture according to an embodiment;

FIG. 5 is a block diagram of an example of a processor according to an embodiment; and

FIG. 6 is a block diagram of an example of a system according to an embodiment.

### DETAILED DESCRIPTION

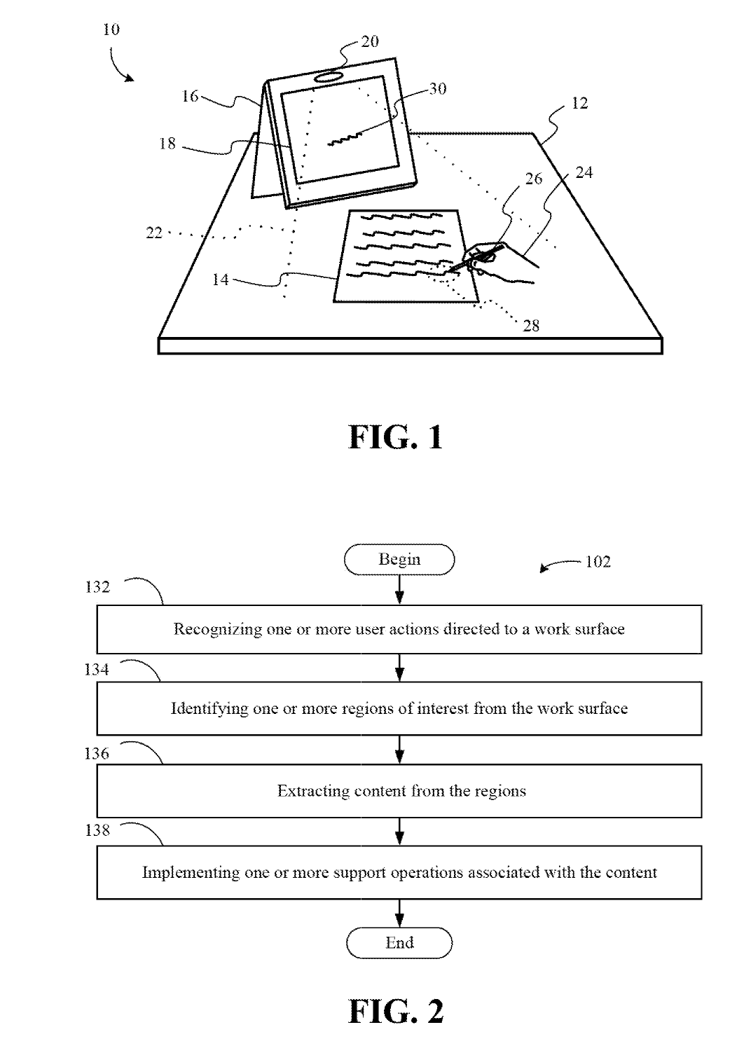

FIG. 1 shows an approach 10 to implement one or more support operations associated with content extracted from one or more regions of interest, related to a work surface, based on one or more user actions according to an embodiment. In the illustrated example, a support 12 may support a work surface 14. The work surface 14 may include any medium to accomplish a task, wherein the task may involve reading, writing, drawing, composing, and so on, or combinations thereof. In addition, the task may be accomplished for any reason. For example, the task may include a personal task (e.g., leisure activity), an academic task (e.g., school assignment activity), a professional task (e.g., employment assignment activity), and so on, or combinations thereof.

In one example, the work surface 14 may involve a display of a computing device and/or data platform, such as a touch screen capable of electronically processing one or more user actions (e.g., a touch action). In another example, the work surface 14 may be incapable of electronically processing one or more of the user actions. The work surface 14 may include, for example, a writing surface incapable of electronically processing one or more of the user actions such as a surface of a piece of paper, of a blackboard (e.g., a chalk board), of a whiteboard (e.g., a marker board), of the support 12 (e.g., a surface of a table), of cardboard, of laminate, of plastic, of wood, and so on, or combinations thereof. The work surface 14 may also include a reading surface incapable of electronically processing one or more of the user actions such as a surface of a magazine, book, newspaper, and so on, or combinations thereof.

In addition, the support 12 may support an apparatus 16. The apparatus 16 may include any computing device and/or data platform such as a laptop, personal digital assistant (PDA), wireless smart phone, media content player, imaging device, mobile Internet device (MID), any smart device such as a smart phone, smart tablet, smart TV, computer server, and so on, or any combination thereof. In one example, the apparatus 16 includes a relatively high-performance mobile platform such as a notebook having a relatively high processing capability (e.g., Ultrabook® convertible notebook, a registered trademark of Intel Corporation in the U.S. and/or other countries). The apparatus 16 may include a display 18, such as a touch screen. For example, the display 18 may be capable of receiving a touch action from the user, and/or may be capable of electronically processing the touch action to achieve a goal associated with the touch action (e.g., highlight a word, cross out a word, select a link, etc.).

In addition, the support 12 may support an image capture device, which may include any device capable of capturing images. In one example, the image capture device may include an integrated camera of a computing device, a front-facing camera, a rear-facing camera, a rotating camera, a 2D (two-dimensional) camera, a 3D (three-dimensional) camera, a standalone camera, and so on, or combinations thereof. In the illustrated example, the apparatus 16 includes an integrated front-facing 2D camera 20, which may be supported by the support 12. The image capture device and/or the display may, however, be positioned at any location. For example, the support 12 may support a standalone camera which may be in communication, over a communication link (e.g., WiFi/Wireless Fidelity, Institute of Electrical and Electronics Engineers/IEEE 802.11-2007, Wireless Local Area Network/LAN Medium Access Control (MAC) and Physical Layer (PHY) Specifications, Ethernet, IEEE 802.3-2005, etc.), with one or more displays that are not disposed on the support 12 (e.g., a wall mounted display). In another example, a standalone camera may be used that is not disposed on the support 12 (e.g., a wall mounted camera), which may be in communication over a communication link with one or more displays whether or not the displays are maintained by the support 12.

In addition, the image capture device may define one or more task areas via a field of view. In the illustrated example, a field of view 22 may define one or more task areas where the user may perform a task (e.g., a reading task, a writing task, a drawing task, etc.) to be observed by the camera 20. For example, one or more of the task areas may be defined by the entire field of view 22, a part of the field of view 22, and so on, or combinations thereof. Accordingly, at least a part of the support 12 (e.g., a surface, an edge, etc.) and/or the work surface 14 (e.g., a surface, an area proximate the user, etc.) may be disposed in the task area and/or the field of view 22 to be observed by the camera 20. Similarly, where a standalone image capture device is used, at least a part of the support 12 and/or the work surface 14 may be located in the task area and/or the field of view of the standalone image capture device, whether or not the standalone image capture device is supported by the support 12.

As will be discussed in greater detail, the apparatus 16 may include a gesture module to recognize one or more user actions. One or more of the user actions may include one or more visible gestures directed to the work surface 14, such as a point gesture, an underline gesture, a circle gesture, mark gesture, a finger gesture, a hand gesture, and so on, or combinations thereof. In one example, one or more of the visible gestures may include a motion, such as a pointing, underlining, circling, and/or marking motion, in a direction of the work surface 14 to request assistance. In addition, one or more of the visible gestures may not involve physically contacting the work surface 14. For example, the user may circle an area over, and spaced apart from, the work surface 14 during a reading operation for assistance. The user may also, for example, point to an area over, and spaced apart from, the work surface 14 during a writing operation for assistance (e.g., lifting a writing implement and pointing, pointing with a finger on one hand while writing with the other, etc.). Accordingly, one or more of the visible gestures may include using one or more fingers, hands, and/or implements for assistance, whether or not one or more of the visible gestures involve contacting the work surface 14.

The implement may include one or more hand-held implements capable of writing and/or incapable of electronically processing one or more of the user actions. In one example, one or more of the hand-held implements may include an ink pen, a marker, chalk, and so on, which may be capable of writing by applying a pigment, a dye, a mineral, etc. to the work surface 14. It should be understood that the hand-held implement may be capable of writing even though it may not be currently loaded (e.g., with ink, lead, etc.) since it may be loaded to accomplish a task. Thus, one or more of the hand-held implements (e.g., ink pen) may be incapable of electronically processing one or more of the user actions, since such a writing utensil may not include electronic capabilities (e.g., electronic sensing capabilities, electronic processing capabilities, etc.). In addition, one or more of the hand-held implements may also be incapable of being used to electronically process one or more of the user actions (e.g., as a stylus), since such a non-electronic writing utensil may cause damage to an electronic work surface (e.g., by scratching a touch screen with a writing tip, by applying a marker pigment to the touch screen, etc.), may not accurately communicate the user actions (e.g., may not accurately communicate the touch action to the touch screen, etc.) and so on, or combinations thereof.

A plurality of visible gestures may be used in any desired order and/or combination. In one example, a plurality of simultaneous visible gestures, of sequential visible gestures (e.g., point and then circle, etc.), and/or of random visible gestures may be used. For example, the user may simultaneously generate a point gesture (e.g., point) directed to the work surface 14 during a reading task using one or more fingers on each hand for assistance, may simultaneously generate a hand gesture (e.g., sway one hand in the field of view 22) while making a point gesture (e.g., pointing a finger of the other hand) directed to the work surface 14 for assistance, and so on, or combinations thereof. In another example, the user may sequentially generate a point gesture (e.g., point) directed to the work surface 14 and then generate a circle gesture (e.g., circling an area) directed to the work surface 14 for assistance. The user may also, for example, generate a point gesture (e.g., tap motion) directed to the work surface 14 one or more times in a random and/or predetermined pattern for assistance. Accordingly, any order and/or combination of user actions may be used to provide hands-free assistance.

In addition, a visible gesture may include physically contacting the work surface 14. In one example, the user may generate an underline gesture (e.g., underline a word, etc.) directed to the work surface 14 using a hand-held implement during a writing task for assistance. In another example, the user may generate a point gesture (e.g., point) directed to the work surface 14 using a finger on one hand and simultaneously generate a mark gesture (e.g., highlight) directed to the work surface 14 using a hand-held implement in the other hand. In the illustrated example, a user's hand 24 may maintain an implement 26 (e.g., ink pen), wherein the gesture module may recognize one or more of the user actions (e.g., a visible gesture) generated by the user hand 24 and/or the implement 26 directed to the work surface 14 (e.g., paper) that occurs in at least a part of the field of view 22 and that is observed by the camera 20.

One or more of the user actions may be observed by the image capture device and/or recognized by the gesture module independently of a physical contact between the user and the image capture device when the user generates one or more of the user actions. In one example, the user may not be required to touch the camera 20 and/or the apparatus 16 in order for the camera 20 to observe one or more of the visible gestures. In another example, the user may not be required to touch the camera 20 and/or the apparatus 16 in order for the gesture module to recognize one or more of the visible gestures. Thus, the user may gesture and/or request assistance in a hands-free operation, for example to minimize any unnecessary burden associated with requiring the user to hold a specialized implement, to hold a camera, to hold the camera still, associated with interrupting a reading operation or a writing operation, and so on.

The apparatus 16 may include a region of interest module to identify one or more regions of interest 28 from the work surface 14. One or more of the regions of interest 28 may be determined based on one or more of the user actions. In one example, the user may generate a visual gesture via the hand 24 and/or the implement 26 directed to the work surface 14 for assistance associated with one or more targets of the visual gesture in the work surface 14. Thus, the visual gesture may cause the region of interest module to determine one or more of the regions of interest 28 having the target from the work surface 14 based on a proximity to the visual gesture, a direction of the visual gesture, a type of the visual gesture, and so on, or combinations thereof. For example, the region of interest module may determine a vector (e.g., the angle, the direction, etc.) corresponding to the visual gesture (e.g., a non-contact gesture) and extrapolate the vector to the work surface 14 to derive one or more of the regions of interest 28. The region of interest module may also, for example, determine a contact area corresponding to the visual gesture (e.g., a contact gesture) to derive one or more of the regions of interest 28. It is to be understood that a plurality of vectors and/or contact areas may be determined by the region of interest module to identify one or more of the regions of interest 28, such as for a combination of gestures, a circle gesture, etc., and so on, or combinations thereof.

In addition, one or more of the regions of interest 28 may be determined based on the content of the work surface 14. In one example, the work surface 14 may include text content and the user may generate a visual gesture to cause the region of interest module to identify one or more word-level regions. For example, the region of interest module may determine that the target of the visual gesture is a word, and identify one or more of the regions of interest 28 to include a word-level region. In another example, the work surface 14 may include text content and the user may generate a visual gesture to cause the region of interest module to identify one or more relatively higher order regions, such as one or more sentence-level regions, and/or relatively lower-level regions, such as one or more letter-level regions. For example, the region of interest module may determine that the target of the visual gesture is a sentence, and identify one or more of the regions of interest 28 to include a sentence-level region, a paragraph-level region, and so on, or combinations thereof. In a further example, the region of interest module may determine that the target includes an object (e.g., landmark, figure, etc.) of image content, a section (e.g., part of a landscape, etc.) of the image content, etc., and identify one or more of the regions of interest 28 to include an object-level region, a section-level region, and so on, or combinations thereof.

In addition, the region of interest module may extract content from one or more of the regions of interest 28. In one example, the region of interest module may extract a word from a word level-region, from a sentence-level region, from a paragraph-level region, from an amorphous-level region (e.g., a geometric region proximate the visual gesture), and so on, or combinations thereof. In another example, the region of interest module may extract a sentence from a paragraph level-region, from an amorphous-level region, and so on, or combinations thereof. The region of interest module may also, for example, extract an object from an object-level region, from a section-level region, and so on, or combinations thereof.

The extraction of content from one or more of the regions of interest 28 may be based on the type of visual gesture (e.g., underline gesture, mark gesture, etc.), the target of the visual gesture (e.g., word target, sentence target, etc.), and/or the content of the work surface 14 (e.g., text, images, etc.). For example, the extraction of a word from one or more of the regions of interest 28 may be based on a mark gesture (e.g., highlighted word), based on a target of a word (e.g., word from an identified sentence-level region), based on image content (e.g., content of a video, picture, frame, etc.), and so on, or combinations thereof. In addition, the content from one or more of the regions of interest 28 may be rendered by another work surface. In the illustrated example, the extracted content from one or more of the regions of interest 28 may be rendered by the display 18 as extracted content 30. It is understood that the extracted content 30 may be displayed at any time, for example stored in a data store and displayed after the work task is completed, displayed in real-time, and so on, or combinations thereof.

The apparatus 16 may also include an assistance module to implement one or more support operations associated with the content 30 from one or more of the regions of interest 28. In one example, one or more of the support operations may include a share operation, an archive operation, a word lookup operation, a read operation, a content transformation operation, and so on, or combinations thereof. For example, the share operation may include providing access to the content 30 by one or more friends, co-workers, family members, community members (e.g., of a social media network, or a living community, etc.), and so on, or combinations thereof. The archive operation may include, for example, storing the content 30 in a data store. The word lookup operation may include providing a synonym of a word, an antonym of the word, a definition of the word, a pronunciation of the word, and so on, or combinations thereof.

The read operation may include reading a bar code (e.g., a quick response/QR code) of the content 30 to automatically link and/or provide a link to further content, such as a website, application (e.g., shopping application), and so on, which may be associated with the barcode. The content transformation operation may include converting the content 30 to a different data format (e.g., PDF, JPEG, RTF, etc.) relative to the original format (e.g., hand-written format, etc.), rendering the re-formatted data, storing the re-formatted data, and so on, or combinations thereof. The content transformation operation may also include converting the content 30 from an original format (e.g., a hand-written format) to an engineering drawing format (e.g., VSD, DWG, etc.), rendering the re-formatted data, storing the re-formatted data, and so on, or combinations thereof.

Turning now to FIG. 2, a method 102 is shown to implement one or more support operations associated with content extracted from one or more regions of interest, related to a work surface, based on one or more user actions. The method 102 may be implemented as a set of logic instructions and/or firmware stored in a machine- or computer-readable storage medium such as random access memory (RAM), read only memory (ROM), programmable ROM (PROM), flash memory, etc., in configurable logic such as, for example, programmable logic arrays (PLAs), field programmable gate arrays (FPGAs), complex programmable logic devices (CPLDs), in fixed-functionality logic hardware using circuit technology such as, for example, application specific integrated circuit (ASIC), CMOS or transistor-transistor logic (TTL) technology, or any combination thereof. For example, computer program code to carry out operations shown in the method 102 may be written in any combination of one or more programming languages, including an object oriented programming language such as C++ or the like and conventional procedural programming languages, such as the “C” programming language or similar programming languages. Moreover, the method 102 may be implemented using any of the herein mentioned circuit technologies.

Illustrated processing block 132 provides for recognizing one or more user actions. In one example, one or more of the user actions may be directed to one or more work surfaces. One or more of the user actions may include one or more visible gestures directed to one or more of the work surfaces. In one example, one or more of the visible gestures may include a point gesture, an underline gesture, a circle gesture, mark gesture, a finger gesture, a hand gesture, and so on, or combinations thereof. For example, one or more of the visible gestures may include a motion, such as a pointing, underlining, circling, and/or marking motion in a direction of the work surface to request assistance. Additionally, one or more of the visible gestures may include using one or more fingers, hands, and/or implements for assistance, whether or not one or more of the visible gestures involve contacting the work surface. For example, one or more of the implements may include a hand-held implement capable of writing and incapable of electronically processing one or more of the user actions. A plurality of visible gestures may be used in any desired order and/or combination. Moreover, one or more or the visible gestures may include and/or exclude physical contact between the user and the work surface.

One or more of the work surfaces may be incapable of electronically processing one or more of the user actions. For example, the work surfaces may include a writing surface such as a surface of a piece of paper, of a blackboard, of a whiteboard, of a support, etc., a reading surface such as a surface of a magazine, book, newspaper, a support, etc., and so on, or combinations thereof. In addition, the user actions may be observed by one or more image capture devices, such as an integrated camera of a computing device and/or data platform, a front-facing camera, a rear-facing camera, a rotating camera, a 2D camera, a 3D camera, a standalone camera, and so on, or combinations thereof.

Additionally, one or more of the image capture devices may be positioned at any location relative to the work surface. The image capture devices may also define one or more task areas via a field of view. In one example, the field of view of the image capture device may define task areas where the user may perform a task to be observed by the image capture device. The task areas may be defined by the entire field of view, a part of the field of view, and so on, or combinations thereof. In another example, user actions occurring in at least a part of one or more of the task areas and/or the field of view may be recognized. Additionally, user actions may be observed by the image capture device and/or recognized independently of a physical contact between the user and the image capture device when the user generates the user actions.

Illustrated processing block 134 provides for identifying one or more regions of interest from the work surface. One or more of the regions of interest may be determined based on the user actions. In one example, the user may generate a user action directed to the work surface for assistance associated with one or more targets of the user action in the work surface, and one or more of the regions of interest having the target from the work surface may be determined based on a proximity to the visual gesture, a direction of the visual gesture, a type of the visual gesture, and so on, or combinations thereof. For example, one or more vectors and/or contact areas may be determined to identify the regions of interest. In another example, regions of interest may be determined based on the content of the work surface. For example, the work surface may include text content, image content, and so on, and the user may generate a visual gesture to cause the identification of one or more word-level regions, sentence-level regions, paragraph-level regions, amorphous-level regions, object level regions, section level-regions, and so on, or combinations thereof. Accordingly, any element may be selected to define a desired granularity for a region of interest, such as a number to define a number-level region, an equation to define an equation-level region, a symbol to define a symbol-level region, and so on, or combinations thereof.

Illustrated processing block 136 provides for extracting content from one or more of the regions of interest. In one example, text content may be extracted from a letter-level region, a word level-region, a sentence-level region, a paragraph-level region, an amorphous-level region, and so on, or combinations thereof. In another example, image content may be extracted from an object-level region, from a section-level region, and so on, or combinations thereof. The extraction of content from one or more of the regions may be based on the type of visual gesture, the target of the visual gesture, the content of the work surface, and so on, or combinations thereof. Moreover, the content extracted from the regions of interest may be rendered by another work surface, which may be capable of electronically processing one or more user actions (e.g., a touch screen capable of electronically processing a touch action). The extracted content may be displayed at any time, for example stored in a data store and displayed after the work task is completed, displayed in real-time, and so on, or combinations thereof.

Illustrated processing block 138 provides for implementing one or more support operations associated with the content from the regions of interest. In one example, the support operations may include a share operation, an archive operation, a word lookup operation, a read operation, a content transformation operation, and so on, or combinations thereof. For example, the share operation may include providing access to the content. The archive operation may include storing the content in a data store. The word lookup operation may include providing information associated with the content, such as a synonym, an antonym, a definition, a pronunciation, and so on, or combinations thereof. The read operation may include reading a 2D code (e.g., a quick response code) of the content to automatically link and/or provide a link to further content. The content transformation operation may include converting the content from an original data format to a different data format, rendering the re-formatted data, storing the re-formatted data, and so on, or combinations thereof.

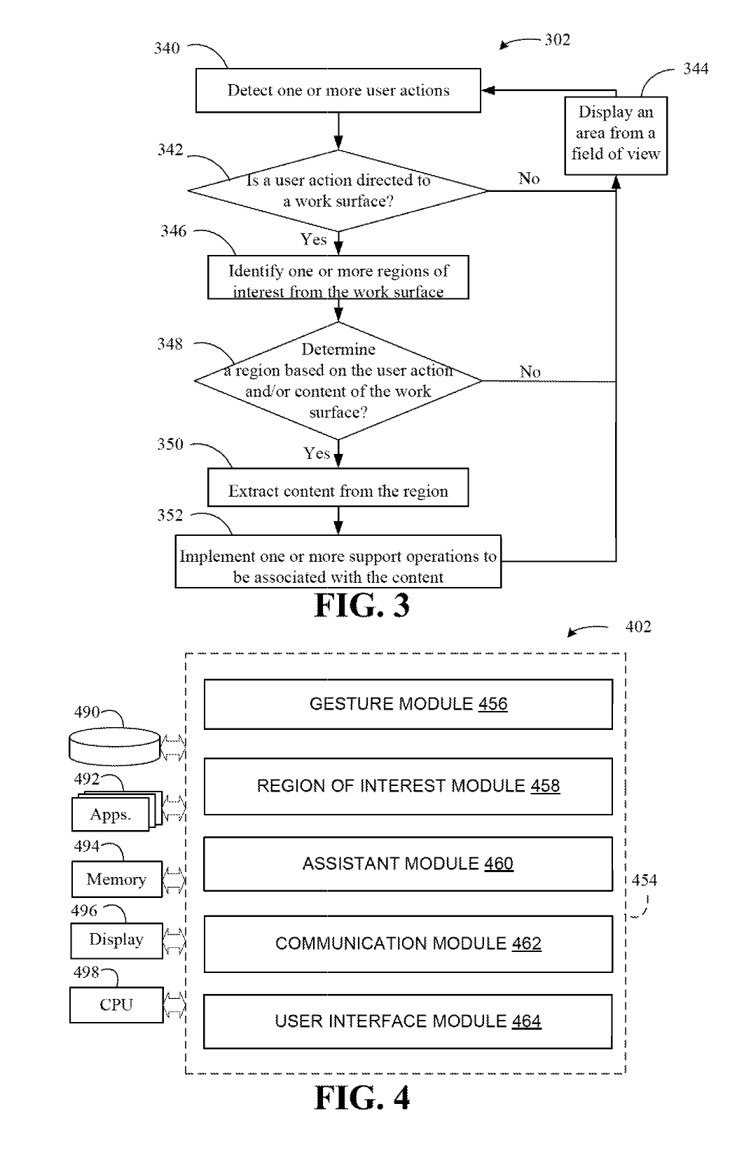

FIG. 3 shows a display-based method 302 to implement one or more support operations associated with content extracted from one or more regions of interest, related to a work surface, based on one or more user actions. The method 302 may be implemented using any of the herein mentioned technologies. Illustrated processing block 340 may detect one or more user actions. For example, a point gesture, an underline gesture, a circle gesture, a mark gesture, a finger gesture, and/or a hand gesture may be detected. In addition, the user action may be observed independently of a physical contact between a user and an image capture device (e.g., hands-free user action). A determination may be made at block 342 if one or more of the user actions are directed to the work surface. If not, processing block 344 may render (e.g., display) an area from a field of view of the image capture device (e.g., a camera), which may observe the work surface, a support, the user (e.g., one or more fingers, hands, etc.), an implement, and so on, or combinations thereof. If one or more of the user actions are directed to the work surface, one or more regions of interest may be identified at processing block 346. For example, the regions of interest identified may include a word-level region, a sentence-level region, a paragraph-level region, an amorphous-level region, an object level region, a section level-region, and so on, or combinations thereof.

A determination may be made at block 348 if one or more of the regions may be determined based on one or more of the user actions and/or the content of the work surface. If not, the processing block 344 may render an area of the field of view of the image capture device, as described above. If so, content may be extracted from one or more of the regions of interest at processing block 350. In one example, the extraction of content from the regions may be based on the type of visual gesture, the target of the visual gesture, the content of the work surface, and so on, or combinations thereof. For example, text content may be extracted from a letter-level region, a word level-region, a sentence-level region, a paragraph-level region, an amorphous-level region, and so on, or combinations thereof. Illustrated processing block 352 may implement one or more support operations associated with the content. For example, the support operations may include a share operation, an archive operation, a word lookup operation, a read operation, a content transformation operation, and so on, or combinations thereof. The processing block 344 may render information associated with the support operations, such as the content extracted and or any support information (e.g., a definition, a link, a file format, etc.).

Turning now to FIG. 4, an apparatus 402 is shown including logic 454 to implement one or more support operations associated with content extracted from one or more regions of interest, related to a work surface, based on one or more user actions. The logic architecture 454 may be generally incorporated into a platform such as such as a laptop, personal digital assistant (PDA), wireless smart phone, media player, imaging device, mobile Internet device (MID), any smart device such as a smart phone, smart tablet, smart TV, computer server, and so on, or combinations thereof. The logic architecture 454 may be implemented in an application, operating system, media framework, hardware component, and so on, or combinations thereof. The logic architecture 454 may be implemented in any component of a work assistance pipeline, such as a network interface component, memory, processor, hard drive, operating system, application, and so on, or combinations thereof. For example, the logic architecture 454 may be implemented in a processor, such as a central processing unit (CPU), a graphical processing unit (GPU), a visual processing unit (VPU), a sensor, an operating system, an application, and so on, or combinations thereof. The apparatus 402 may include and/or interact with storage 490, applications 492, memory 494, display 496, CPU 498, and so on, or combinations thereof.

In the illustrated example, the logic architecture 454 includes a gesture module 456 to recognize one or more user actions. The user actions may include, for example, a point gesture, an underline gesture, a circle gesture, mark gesture, a finger gesture, or a hand gesture. In addition, the user actions may include a hand-held implement capable of writing and incapable of electronically processing one or more of the user actions, such as an ink pen. The user actions may also be observed by an image capture device. In one example, the user actions may be observed by a 2D camera of a mobile platform, which may include relatively high processing power to maximize recognition capability (e.g., a convertible notebook). The user actions may occur, for example, in at least a part of a field of view of the 2D camera. The user actions that are recognized by the gesture module 456 may be directed to a work surface, such as a work surface incapable of electronically processing the user actions (e.g., paper). In addition, the user actions observed by the image capture device and/or recognized by the gesture module 456 may be independent of a physical contact between the user and the image capture device (e.g., hands-free operation).

Additionally, the illustrated logic architecture 454 may include a region of interest module 458 to identify one or more regions of interest from the work surface and/or to extract content from one or more of the regions of interest. In one example, the regions of interest may be determined based on one or more of the user actions. For example, the region of interest module 458 may determine the regions of interest from the work surface based on a proximity to one or more of the user action, a direction of one or more of the user actions, a type of one or more of the user actions, and so on, or combinations thereof. In another example, the regions of interest may be determined based on the content of the work surface. For example, the region of interest module 458 may identify a word-level region, a sentence-level region, a paragraph-level region, an amorphous-level region, an object level region, a section level-region, and so on, or combinations thereof.

In addition, the region of interest module 458 may extract content from one or more of the regions of interest based on, for example, the type of one or more user actions, the target of one or more of the user actions, the content of one or more work surfaces, and so on, or combinations thereof. Moreover, the content extracted from the regions of interest may be rendered by another work surface, such as by the display 496 which may be capable of electronically processing user actions (e.g., a touch screen capable of processing a touch action). The extracted content may be displayed at any time, for example stored in the data storage 490 and/or the memory 494 and displayed (e.g., via applications 492) after the work operation is completed, displayed in real-time, and so on, or combinations thereof.

Additionally, the illustrated logic architecture 454 may include an assistant module 460 to implement one or more support operations associated with the content. In one example, the support operations may include a share operation, an archive operation, a word lookup operation, a read operation, a content transformation operation, and so on, or combinations thereof. For example, the share operation may include providing access to the content. The archive operation may include storing the content in a data store, such as the storage 490, the memory 494, and so on, or combinations thereof. The word lookup operation may include providing information associated with the content, for example at the display 496, such as a synonym, an antonym, a definition, a pronunciation, and so on, or combinations thereof. The read operation may include reading a 2D code (e.g., a QR code) of the content to automatically link and/or provide a link to further content, for example at the applications 492, the display 496, and so on, or combinations thereof. The content transformation operation may include converting the content from an original data format to a different data format, rendering the re-formatted data, storing the re-formatted data (e.g., using the storage 490, the applications 492, the memory 494, the display 496 and/or the CPU 498), and so on, or combinations thereof.

Additionally, the illustrated logic architecture 454 may include a communication module 462. The communication module may be in communication and/or integrated with a network interface to provide a wide variety of communication functionality, such as cellular telephone (e.g., W-CDMA (UMTS), CDMA2000 (IS-856/IS-2000), etc.), WiFi, Bluetooth (e.g., IEEE 802.15.1-2005, Wireless Personal Area Networks), WiMax (e.g., IEEE 802.16-2004, LAN/MAN Broadband Wireless LANS), Global Positioning Systems (GPS), spread spectrum (e.g., 900 MHz), and other radio frequency (RF) telephony purposes.

Additionally, the illustrated logic architecture 454 may include a user interface module 464. The user interface module 464 may provide any desired interface, such as a graphical user interface, a command line interface, and so on, or combinations thereof. The user interface module 464 may provide access to one or more settings associated with work assistance. The settings may include options to, for example, define one or more user actions (e.g., a visual gesture), define one or more parameters to recognize one or more user actions (e.g., recognize if directed to a work surface), define one or more image capture devices (e.g., select a camera), define one or more fields of view (e.g., visual field), task areas (e.g., part of the field of view), work surfaces (e.g., surface incapable of electronically processing), content (e.g., recognize text content), regions of interest (e.g., word-level region), parameters to identify one or more regions of interest (e.g., use vectors), parameters to extract content from one or more regions of interest (e.g., extract words based on determined regions), parameters to render content (e.g., render at another work surface), support operations (e.g., provide definitions), and so forth. The settings may include automatic settings (e.g., automatically provide support operations when observing one or more user actions), manual settings (e.g., request the user to manually select and/or confirm the support operation), and so on, or combinations thereof.

While examples have shown separate modules for illustration purposes, it should be understood that one or more of the modules of the logic architecture 454 may be implemented in one or more combined modules, such as a single module including one or more of the gesture module 456, the region of interest module 458, the assistant module 460, the communication module 462, and/or the user interface module 464. In addition, it should be understood that one or more logic components of the apparatus 402 may be on platform, off platform, and/or reside in the same or different real and/or virtual space as the apparatus 402. For example, the gesture module 456, the region of interest module 458, and/or the assistant module 460 may reside in a computing cloud environment on a server while one or more of the communication module 462 and/or the user interface module 464 may reside on a computing platform where the user is physically located, and vice versa, or combinations thereof. Accordingly, the modules may be functionally separate modules, processes, and/or threads, may run on the same computing device and/or distributed across multiple devices to run concurrently, simultaneously, in parallel, and/or sequentially, may be combined into one or more independent logic blocks or executables, and/or are described as separate components for ease of illustration.

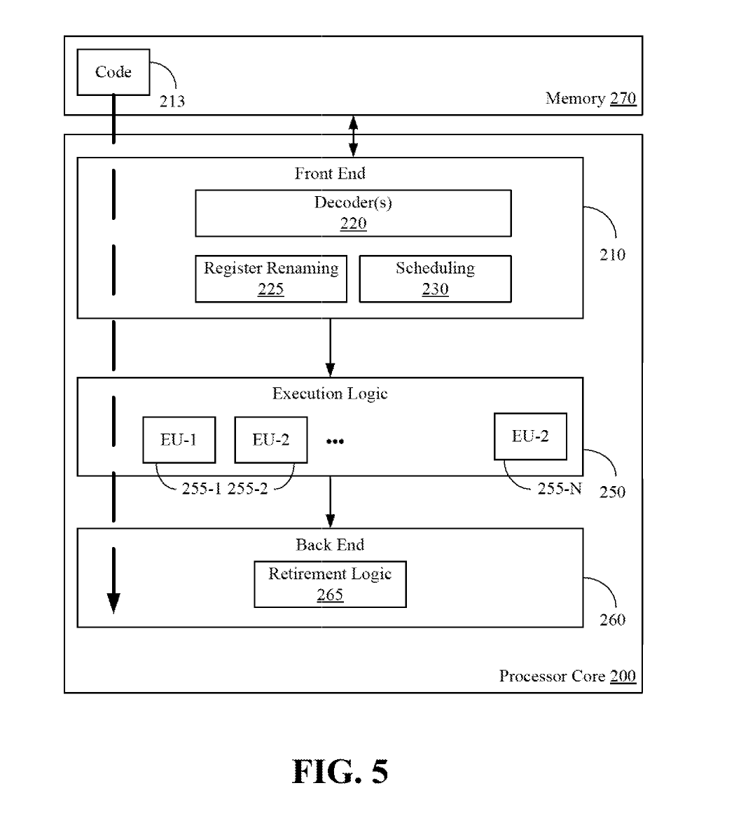

Turning now to FIG. 5, a processor core 200 according to one embodiment is shown. In one example, one or more portions of the processor core 200 may be included in any computing device and/or data platform, such as the apparatus 16 described above. The processor core 200 may be the core for any type of processor, such as a micro-processor, an embedded processor, a digital signal processor (DSP), a network processor, or other device to execute code to implement the technologies described herein. Although only one processor core 200 is illustrated in FIG. 5, a processing element may alternatively include more than one of the processor core 200 illustrated in FIG. 5. The processor core 200 may be a single-threaded core or, for at least one embodiment, the processor core 200 may be multithreaded in that it may include more than one hardware thread context (or “logical processor”) per core.

FIG. 5 also illustrates a memory 270 coupled to the processor 200. The memory 270 may be any of a wide variety of memories (including various layers of memory hierarchy) as are known or otherwise available to those of skill in the art. The memory 270 may include one or more code 213 instruction(s) to be executed by the processor 200 core, wherein the code 213 may implement the logic architecture 454 (FIG. 4), already discussed. The processor core 200 follows a program sequence of instructions indicated by the code 213. Each instruction may enter a front end portion 210 and be processed by one or more decoders 220. The decoder 220 may generate as its output a micro operation such as a fixed width micro operation in a predefined format, or may generate other instructions, microinstructions, or control signals which reflect the original code instruction. The illustrated front end 210 also includes register renaming logic 225 and scheduling logic 230, which generally allocate resources and queue the operation corresponding to the convert instruction for execution.

The processor 200 is shown including execution logic 250 having a set of execution units 255-1 through 255-N. Some embodiments may include a number of execution units dedicated to specific functions or sets of functions. Other embodiments may include only one execution unit or one execution unit that may perform a particular function. The illustrated execution logic 250 performs the operations specified by code instructions.

After completion of execution of the operations specified by the code instructions, back end logic 260 retires the instructions of the code 213. In one embodiment, the processor 200 allows out of order execution but requires in order retirement of instructions. Retirement logic 265 may take a variety of forms as known to those of skill in the art (e.g., re-order buffers or the like). In this manner, the processor core 200 is transformed during execution of the code 213, at least in terms of the output generated by the decoder, the hardware registers and tables utilized by the register renaming logic 225, and any registers (not shown) modified by the execution logic 250.

Although not illustrated in FIG. 5, a processing element may include other elements on chip with the processor core 200. For example, a processing element may include memory control logic along with the processor core 200. The processing element may include I/O control logic and/or may include I/O control logic integrated with memory control logic. The processing element may also include one or more caches.

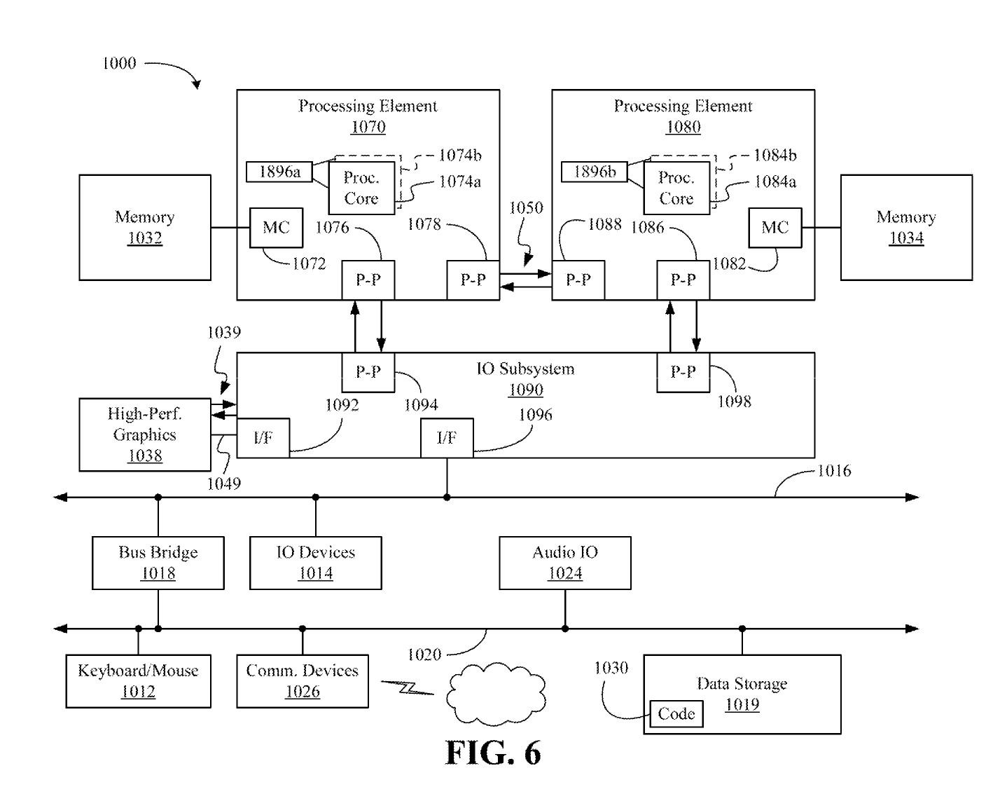

FIG. 6 shows a block diagram of a system 1000 in accordance with an embodiment. In one example, one or more portions of the processor core 200 may be included in any computing device and/or data platform, such as the apparatus 16 described above. Shown in FIG. 6 is a multiprocessor system 1000 that includes a first processing element 1070 and a second processing element 1080. While two processing elements 1070 and 1080 are shown, it is to be understood that an embodiment of system 1000 may also include only one such processing element.

System 1000 is illustrated as a point-to-point interconnect system, wherein the first processing element 1070 and second processing element 1080 are coupled via a point-to-point interconnect 1050. It should be understood that any or all of the interconnects illustrated in FIG. 6 may be implemented as a multi-drop bus rather than point-to-point interconnect.

As shown in FIG. 6, each of processing elements 1070 and 1080 may be multicore processors, including first and second processor cores (i.e., processor cores 1074a and 1074b and processor cores 1084a and 1084b). Such cores 1074, 1074b, 1084a, 1084b may be configured to execute instruction code in a manner similar to that discussed above in connection with FIG. 5.

Each processing element 1070, 1080 may include at least one shared cache 1896. The shared cache 1896a, 1896b may store data (e.g., instructions) that are utilized by one or more components of the processor, such as the cores 1074a. 1074b and 1084a, 1084b, respectively. For example, the shared cache may locally cache data stored in a memory 1032, 1034 for faster access by components of the processor. In one or more embodiments, the shared cache may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope is not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There may be a variety of differences between the processing elements 1070, 1080 in terms of a spectrum of metrics of merit including architectural, microarchitectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

First processing element 1070 may further include memory controller logic (MC) 1072 and point-to-point (P-P) interfaces 1076 and 1078. Similarly, second processing element 1080 may include a MC 1082 and P-P interfaces 1086 and 1088. As shown in FIG. 6, MC's 1072 and 1082 couple the processors to respective memories, namely a memory 1032 and a memory 1034, which may be portions of main memory locally attached to the respective processors. While the MC logic 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076, 1086 and 1084, respectively. As shown in FIG. 10, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple graphics engine 1038 to I/O subsystem 1090. Alternately, a point-to-point interconnect 1039 may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope is not so limited.

As shown in FIG. 6, various I/O devices 1014 such as the display 18 (FIG. 1) and/or display 496 (FIG. 4) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, communication device(s) 1026 (which may in turn be in communication with a computer network), and a data storage unit 1019 such as a disk drive or other mass storage device which may include code 1030, in one embodiment. The code 1030 may include instructions for performing embodiments of one or more of the methods described above. Thus, the illustrated code 1030 may implement the logic architecture 454 (FIG. 4), already discussed. Further, an audio I/O 1024 may be coupled to second bus 1020.

Note that other embodiments are contemplated. For example, instead of the point-to-point architecture of FIG. 6, a system may implement a multi-drop bus or another such communication topology. Also, the elements of FIG. 6 may alternatively be partitioned using more or fewer integrated chips than shown in FIG. 6.

### Additional Notes and Examples

Examples can include subject matter such as a method, means for performing acts of the method, at least one machine-readable medium including instructions that, when performed by a machine cause the machine to performs acts of the method, or of an apparatus or system for providing assistance according to embodiments and examples described herein.

Example 1 is as an apparatus to provide assistance, comprising an image capture device to observe a user action directed to a work surface incapable of electronically processing the user action, a gesture module to recognize the user action, a region of interest module to identify a region from the work surface based on the user action and to extract content from the region, and assistant module to implement a support operation to be associated with the content.

Example 2 includes the subject matter of Example 1 and further optionally includes an image capture device including a camera of a mobile platform.

Example 3 includes the subject matter of any of Example 1 to Example 2 and further optionally includes at least one region of interest including a word-level region, and wherein the content is a word.

Example 4 includes the subject matter of any of Example 1 to Example 3 and further optionally includes at least one region of interest rendered by another work surface.

Example 5 includes the subject matter of any of Example 1 to Example 4 and further optionally includes at least one operation selected from the group of a share operation, an archive operation, a word lookup operation, a read operation, or a content transformation operation.

Example 6 includes the subject matter of any of Example 1 to Example 5 and further optionally includes the gesture module to recognize at least one user action selected from the group of a point gesture, an underline gesture, a circle gesture, mark gesture, a finger gesture, or a hand gesture to be directed to the work surface.

Example 7 includes the subject matter of any of Example 1 to Example 6 and further optionally includes the gesture module to recognize at least one user action including a hand-held implement capable of writing and incapable of electronically processing the user action.

Example 8 includes the subject matter of any of Example 1 to Example 7 and further optionally includes the gesture module to recognize at least one user action occurring independently of a physical contact between a user and the image capture device.

Example 9 is a computer-implemented method for providing assistance, comprising recognizing a user action observed by an image capture device, wherein the user action is directed to a work surface incapable of electronically processing the user action, identifying a region of interest from the work surface based on the user action and extracting content from the region, and implementing a support operation associated with the content.

Example 10 includes the subject matter of Example 9 and further optionally includes recognizing at least one user action occurring in at least part of a field of view of the image capture device.

Example 11 includes the subject matter of any of Example 9 to Example 10 and further optionally includes identifying at least one word-level region of interest.

Example 12 includes the subject matter of any of Example 9 to Example 11 and further optionally includes rendering at least one region of interest by another work surface.

Example 13 includes the subject matter of any of Example 9 to Example 12 and further optionally includes implementing at least one operation selected from the group of a sharing operation, an archiving operation, a word lookup operation, a reading operation, or a content transformation operation.

Example 14 includes the subject matter of any of Example 9 to Example 13 and further optionally includes recognizing at least one user action selected from the group of a point gesture, an underline gesture, a circle gesture, mark gesture, a finger gesture, or a hand gesture directed to the work surface.

Example 15 includes the subject matter of any of Example 9 to Example 14 and further optionally includes recognizing at least one user action including a hand-held implement capable of writing and incapable of electronically processing one or more of user actions.

Example 16 includes the subject matter of any of Example 9 to Example 15 and further optionally includes recognizing at least one user action occurring independently of a physical contact between a user and the image capture device.

Example 17 is at least one computer-readable medium including one or more instructions that when executed on one or more computing devices causes the one or more computing devices to perform the method of any of Example 9 to Example 16.

Example 18 is an apparatus including means for performing the method of any of Example 9 to Example 16.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Embodiments are applicable for use with all types of semiconductor integrated circuit (“IC”) chips. Examples of these IC chips include but are not limited to processors, controllers, chipset components, programmable logic arrays (PLAs), memory chips, network chips, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments may be practiced without, or with variation of, these specific details. The description is thus to be regarded as illustrative instead of limiting.

Some embodiments may be implemented, for example, using a machine or tangible computer-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Unless specifically stated otherwise, it may be appreciated that terms such as “processing,” “computing,” “calculating.” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated. Additionally, it is understood that the indefinite articles “a” or “an” carry the meaning of“one or more” or “at least one”. In addition, as used in this application and in the claims, a list of items joined by the term “one or more of” and/or “at least one of” can mean any combination of the listed terms. For example, the phrases “one or more of A, B or C” can mean A; B; C; A and B; A and C; B and C; or A, B and C.

Those skilled in the art will appreciate from the foregoing description that the broad techniques of the embodiments may be implemented in a variety of forms. Therefore, while the embodiments have been described in connection with particular examples thereof, the true scope of the embodiments should not be so limited since other modifications will become apparent to the skilled practitioner upon a study of the drawings, the specification, and following claims.

1-18. (canceled)

19. An apparatus to provide assistance, comprising:
an image capture device to observe a user action directed to a work surface incapable of electronically processing the user action;
a gesture module to recognize the user action;
a region of interest module to identify a region from the work surface based on the user action and to extract content from the region; and
an assistant module to implement a support operation to be associated with the content.

20. The apparatus of claim 19, wherein the image capture device includes a camera of a mobile platform.

21. The apparatus of claim 19, wherein at least one region of interest includes a word-level region, and wherein the content is a word.

22. The apparatus of claim 19, wherein at least one region of interest is to be rendered by another work surface.

23. The apparatus of claim 19, wherein at least one operation is selected from the group of a share operation, an archive operation, a word lookup operation, a read operation, or a content transformation operation.

24. The apparatus of claim 19, wherein the gesture module is to recognize at least one user action selected from the group of a point gesture, an underline gesture, a circle gesture, mark gesture, a finger gesture, or a hand gesture to be directed to the work surface.

25. The apparatus of claim 19, wherein the gesture module is to recognize at least one user action including a hand-held implement capable of writing and incapable of electronically processing the user action.

26. The apparatus of claim 19, wherein the gesture module is to recognize at least one user action occurring independently of a physical contact between a user and the image capture device.

27. A computer-implemented method providing assistance, comprising:
recognizing a user action observed by an image capture device, wherein the user action is directed to a work surface incapable of electronically processing the user action;
identifying a region of interest from the work surface based on the user action and extracting content from the region; and
implementing a support operation associated with the content.

28. The method of claim 27, further including recognizing at least one user action occurring in at least part of a field of view of the image capture device.

29. The method of claim 27, further including identifying at least one word-level region of interest.

30. The method of claim 27, further including rendering at least one region of interest by another work surface.

31. The method of claim 27, further including implementing at least one operation selected from the group of a sharing operation, an archiving operation, a word lookup operation, a reading operation, or a content transformation operation.

32. The method of claim 27, further including recognizing at least one user action selected from the group of a point gesture, an underline gesture, a circle gesture, mark gesture, a finger gesture, or a hand gesture directed to the work surface.

33. The method of claim 27, further including recognizing at least one user action including a hand-held implement capable of writing and incapable of electronically processing one or more of user actions.

34. The method of claim 27, further including recognizing at least one user action occurring independently of a physical contact between a user and the image capture device.

35. At least one computer-readable medium comprising one or more instructions that when executed on a computing device cause the computing device to:
recognize a user action observed by an image capture device, wherein the user action is directed to a work surface incapable of electronically processing the user actions;
identify a region of interest from the work surface based on the user action and extract content from the region; and
implement a support operation to be associated with the content.

36. The at least one medium of claim 35, wherein when executed the one or more instructions cause the computing device to recognize at least one user action occurring in at least part of a field of view of the image capture device.

37. The at least one medium of claim 35, wherein when executed the one or more instructions cause the computing device to identify at least one word-level region of interest.

38. The at least one medium of claim 35, wherein when executed the one or more instructions cause the computing device to render at least one region of interest by another work surface.

39. The at least one medium of claim 35, wherein when executed the one or more instructions cause the computing device to implement at least one operation selected from the group of a share operation, an archive operation, a word lookup operation, a read operation, or a content transformation operation.

40. The at least one medium of claim 35, wherein when executed the one or more instructions cause the computing device to recognize at least one user action selected from the group of a point gesture, an underline gesture, a circle gesture, mark gesture, a finger gesture, or a hand gesture to be directed to the work surface.

41. The at least one medium of claim 35, wherein when executed the one or more instructions cause the computing device to recognize at least one user action including a hand-held implement capable of writing and incapable of electronically processing the user action.

42. The at least one medium of claim 35, wherein when executed the one or more instructions cause the computing device to recognize at least one user action occurring independently of a physical contact between a user and the image capture device.
